(19) United States
(12) Patent Application Publication
(10) Pub. No.: US 2025/0059808 A1
(43) Pub. Date: Feb. 20, 2025

(54) DOOR HOLDER AND RELEASE SYSTEM

(71) Applicant: ASSA ABLOY Accessories and Door Controls Group, Inc., Monroe, NC (US)

(72) Inventor: Jason Devinney, Concord, NC (US)

(73) Assignee: ASSA ABLOY Accessories and Door Controls Group, Inc., Monroe, NC (US)

(21) Appl. No.: 18/800,536

(22) Filed: Aug. 12, 2024

Related U.S. Application Data
(60) Provisional application No. 63/533,455, filed on Aug. 18, 2023.

(51) Int. Cl. E05C 17/56; E05C 17/58

(52) U.S. Cl. CPC E05C 17/56; E05C 17/58

(57) ABSTRACT

A door holder and release system having a release apparatus and a door holder. The release apparatus utilizes a switchable permanent magnet, a drive (motor, actuator, or the like), and an energy storage device (e.g., capacitor, battery, or the like). The door holder may be a static or dynamic door holder. When a door is held open by the release apparatus, minimum power is drawn from a power supply to maintain the charge of the energy storage device. During a disengagement event, such as a power loss event (e.g., in the event of a fire, or the like) or a disengagement request, the drive is powered by the energy storage device in order to reduce (e.g., remove, minimize, redirect, or the like) the magnetic field in the switchable permanent magnet such that the release apparatus disengages from the door holder such that the door closes.

### PRIORITY CLAIM UNDER 35 U.S.C. § 119

The present application for a patent claims priority to U.S. Provisional Patent Application Ser. No. 63/533,455 entitled “Door Holder and Release System,” filed on Aug. 18, 2023, both of which are assigned to the assignee hereof and hereby expressly incorporated by reference herein.

### FIELD

The present invention relates to a door holder and release system, and in particular, a release apparatus for a door holder and release system.

### BACKGROUND

Door holder and release systems are used to hold a door in an open position. Door holders and release systems may be mounted in between a support (e.g., wall, floor, support member, such as a pole, a beam, or the like) and a door. Door holders and release systems may be magnetically, electromagnetically, mechanically, and/or electromechanically operated.

### SUMMARY

Embodiments of the present disclosure relate to a door holder and release system having a release apparatus and a door holder. The release apparatus may utilize a magnet, such as a switchable permanent magnet, operatively coupled to a drive (e.g., a motor, an actuator, or the like) directly, or indirectly through a drive train (e.g., gears, or the like). The release apparatus may further utilize an energy storage device (e.g., capacitor, battery, or the like) that is operatively coupled to a power supply that allows the energy storage device to receive power and store the power within the energy storage device. The door holder may be any type of door holder such as a static door holder (e.g., a metal plate, or the like) or a dynamic door holder with one or more degrees of freedom (e.g., a pivot door holder, a ball and socket door holder, or the like), an adjustable door holder (e.g., allows for the adjustment of the location at which the door holder engages the release apparatus). The door holder may be made out of any material that is attracted to a magnet (e.g., magnetic material, such as a ferromagnetic metal).

As will be described in further detail herein, when a door is being held open (e.g., through the release apparatus engaging the door holder), minimum power is drawn from the power supply to charge (e.g., add power to, maintain the power of, or the like) the energy storage device. During a disengagement event, such as a power loss event (e.g., in the event of a fire, power outage, flood, or other like event that may cause a power outage), a disengagement request (e.g., a termination of hold-open signal through a wired or wireless connection), or the like, the drive (e.g., motor, actuator, or the like) is powered by the energy storage device in order to reduce the magnetic field (e.g., minimize the magnetic field, remove the magnetic field, redirect the magnetic field, or the like) such that the release apparatus disengages from the door holder. For example, in some embodiments, the magnet is a switchable magnet, and the drive is a motor that is utilized to move (e.g., rotate, or the like) at least one of the magnets in order to reduce the magnetic field (e.g., minimize, redirect, remove, or the like) to release the door holder such that the door moves from an open position to a closed position. That is, when the magnetic field of the magnet is reduced (e.g., minimized, redirected, removed, or the like) to the point that the holding force between the magnet and the door holder is overcome by the closing force of the door, the magnet and the door holder will disengage and the door will close (e.g., through the weight of the door, a door closer, door operator, biased springs, biased hinges, or the like).

One embodiment of the invention is a release apparatus for a door holder and release system. The release apparatus comprises a magnet, a drive operatively coupled to the magnet, and an energy storage device operatively coupled to the drive. The energy storage device is configured to be operatively coupled to a power supply for storing energy in the energy storage device. During a disengagement event when the power supply is reduced, the energy storage device powers the drive to switch the magnet to reduce a magnetic field of the magnet.

In further accord with embodiments, the magnet is a switchable permanent magnet.

In other embodiments, the energy storage device comprises a capacitor.

In yet other embodiments, the energy storage device comprises a battery.

In still other embodiments, the release apparatus further comprises a drive train operatively coupled to the magnet. The drive is a motor or an actuator, and the drive train increases torque or reduces current of the motor or the actuator.

In other embodiments, the energy storage device utilizes 10 milliamps or less to charge the energy storage device.

In further accord with embodiments, the power supply operatively coupled to the energy storage device comprises a 12V, 18V, 24V, or 120V power supply.

In other embodiments, the power supply operatively coupled to the energy storage device comprises power over ethernet.

In yet other embodiments, the release apparatus further comprises a sensor for sending a signal to indicate a status of the magnet.

In still other embodiments, the sensor is a magnetic bond sensor, and the signal indicates when the magnet is engaged or disengaged or a magnet holding force.

In other embodiments, the release apparatus further comprises a controller. The controller comprises one or more memories having computer readable code stored thereon, and one or more processing devices operatively coupled to the one or more memories. When executed the computer readable code is configured to cause the one or more processing devices to receive a selection of a holding force for the magnet, and activate the drive to adjust the magnet to set the holding force.

In further accord with embodiments, the release apparatus further comprising a controller. The controller comprises one or more memories having computer readable code stored thereon and one or more processing devices operatively coupled to the one or more memories. When executed the computer readable code is configured to cause the one or more processing devices to receive a signal to activate the drive, and engage the drive to reduce the magnetic field from the magnet.

In other embodiments, the signal is a loss of power from the power supply, and engaging the motor to reduce the magnetic field comprises using the energy storage device to provide the power the motor.

Another embodiment of the invention is a door holder and release system. The system comprises a door holder configured to be operatively coupled with a door and a release apparatus configured for operative coupling with a support. The release apparatus comprises a magnet, a drive operatively coupled to the magnet, and an energy storage device operatively coupled to the drive. The energy storage device is configured to be operatively coupled to a power supply for storing energy in the energy storage device. During a disengagement event when the power supply is interrupted, the energy storage device powers the drive to switch the magnet to reduce a magnetic field of the magnet.

In further accord with embodiments, the magnet is a switchable permanent magnet, and wherein the energy storage device comprises a capacitor.

In other embodiments, the release apparatus further comprises a drive train operatively coupled to the magnet and the drive. The drive is a motor or an actuator, and the drive train increases torque or reduces current of the motor or the actuator.

In yet other embodiments, the energy storage device utilizes 10 milliamps or less to charge the energy storage device.

In still other embodiments, the power supply operatively coupled to the energy storage device comprises a 12V, 18V, 24V, or 120V power supply or power over ethernet.

In other embodiments, the release apparatus further comprises a controller. The controller comprises one or more memories having computer readable code stored thereon, and one or more processing devices operatively coupled to the one or more memories. When executed the computer readable code is configured to cause the one or more processing devices to receive a signal to activate the drive, and engage the drive to reduce the magnetic field from the magnet.

Another embodiment of the invention is a method of controlling a release apparatus of a door holder and release system. The release apparatus comprises a magnet, a drive operatively coupled to the magnet, and an energy storage device operatively coupled to the drive. The method comprises identifying a disengagement event, and activating the drive using the energy storage device to power the drive to reduce a magnetic field of the magnet.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

The following drawings illustrate embodiments of the invention and are not necessarily drawn to scale, wherein:

FIG. 1 illustrates a perspective view of a door holder and release system, in accordance with some embodiments of the present disclosure.

FIG. 2 illustrates a top view of a door holder and release system installed on a door and wall, in accordance with some embodiments of the present disclosure.

FIG. 3 illustrates a schematic block diagram of a release apparatus, in accordance with some embodiments of the present disclosure.

FIG. 4A illustrates a representation of the release apparatus of the door holder and release system having a switchable permanent magnet in an aligned position, in accordance with some embodiments of the present disclosure.

FIG. 4B illustrates a representation of the release apparatus of the door holder and release system having a switchable permanent magnet in a misaligned position, in accordance with some embodiments of the present disclosure.

FIG. 5A illustrates the release apparatus of the door holder and release system in the process of being disengaged, in accordance with some embodiments of the present disclosure.

FIG. 5B illustrates the release apparatus of the door holder and release system in the process of being engaged, in accordance with some embodiments of the present disclosure.

FIG. 6 is a process flow for installing and operating the door holder and release system, in accordance with some embodiments of the present disclosure.

FIG. 7 illustrates a release network environment system, in accordance with some embodiments of the present disclosure.

### DETAILED DESCRIPTION

Embodiments of the present invention may now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

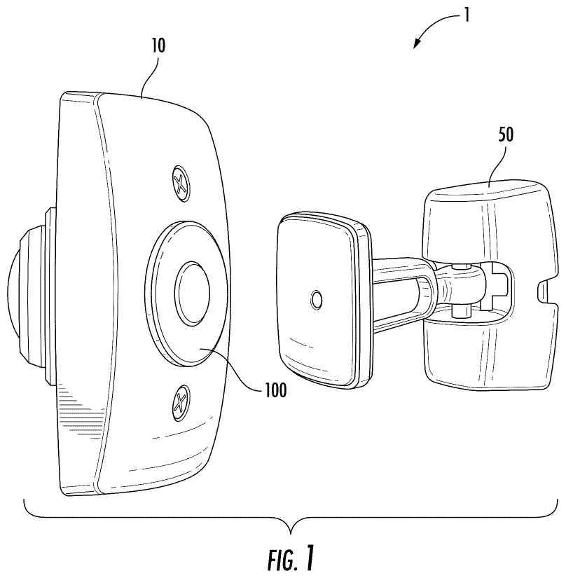

FIGS. 1 through 5B illustrate a door holder and release system 1 having a release apparatus 10 and a door holder 50. As will be described in further detail herein, the release apparatus 10 may utilize a magnet 100, such as a switchable permanent magnet 101 (e.g., having a first permanent magnet 102 and a second permanent magnet 104) operatively coupled to a drive (e.g., a motor 150, an actuator, or the like) directly, or indirectly through a drive train 120 (e.g., gears, or the like). The release apparatus 10 may further utilize an energy storage device 170 (e.g., capacitor, battery, or the like) that is operatively coupled to a power supply 90 that allows the energy storage device 170 to receive power (e.g., otherwise described as energy) and store the power within the energy storage device 170. The door holder 50 may be any type of door holder 50 such as a static door holder 50 (e.g., a metal plate, or the like), a dynamic door holder 50 with one or more degrees of freedom (e.g., a pivot door holder, a ball and socket door holder, or the like), an adjustable door holder (e.g., allows for the adjustment of the location at which the door holder engages the release apparatus 10), or other like door holder. The door holder 50 may be made out of any material that is attracted to a magnet (e.g., magnetic material, such as a ferromagnetic metal).

As will be described in further detail herein, when a door 4 is being held open (e.g., through the release apparatus 10 engaging the door holder 50), minimum power is drawn from the power supply 90 to charge (e.g., add power to, maintain the power of, or the like) the energy storage device 170. During a disengagement event, such as a power loss event (e.g., in the event of a fire, power outage, flood, or the like event that may cause a power outage), or through a disengagement request (e.g., through the use of a wired or wireless signal made by a user, a computer system, or the like), the drive (e.g., the motor 150, the actuator, or the like) is powered by the energy storage device 170 in order to reduce the magnetic field (e.g., minimize the magnetic field, remove the magnetic field, or the like) such that the release apparatus 10 disengages from the door holder 50. For example, in some embodiments the magnet 100 is a switchable magnet 101, and the drive (e.g., motor 150, actuator, or the like) is utilized to move (e.g., rotate, or the like) at least one of the magnets (e.g., the first permanent magnet 102 or the second permanent magnet 104) in order to reduce the magnetic field to release the door holder 50 such that the door 4 moves from an open position to a closed position. That is, when the magnetic field of the magnet 100 is reduced to the point that the holding force between the magnet 100 and the door holder 50 is overcome by the closing force of the door 4, the magnet 100 and the door holder 50 will disengage and the door will close (e.g., through the weight of the door, a door closer, door operator, biased springs, biased hinges, or the like).

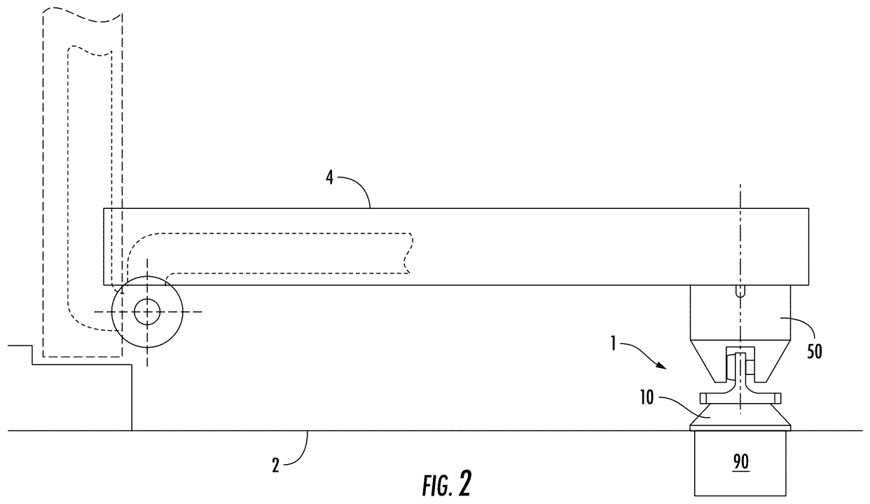

As illustrated in FIG. 2, the release apparatus 10 may be operatively coupled to a wall 2 adjacent a power supply 90. The power supply 90 may be any type of wired or wireless power supply. In some embodiments, the power supply 90 may be a 120V outlet (or other outlet voltage, such as 110V, 220V, 230V, or the like), power over ethernet (PoE), battery storage, low voltage (e.g., 5V, 12V, 18V, 24V, or the like) from a central supply and wired with low voltage wire, or other like power supply. In other embodiments, the release apparatus 10 may be operatively coupled to the floor. In still other embodiments, the release apparatus 10 maybe operatively coupled to a support member (e.g., pole, beam, or the like). As such, it should be understood that the release apparatus 10 may be operatively coupled to any type of support (e.g., wall 2, floor, a support member, such as vertical support, horizontal support, or the like). Alternatively, the door holder 50 may be operatively coupled to any type of barrier (e.g., a door 4, or the like) that moves (e.g., swings, slides, rotates, pivots, or the like) between one or more open and/or closed positions, and moreover, may be located on any portion of the barrier (e.g., face, side edge, bottom edge, or the like). It should be understood that the barrier (e.g., door 4, or the like) may be mechanically, electrically, and/or manually opened and/or closed, such as through the use of door operators, door closers, or the like that utilize motors, actuators, springs, hinges, or other types of closing devices for aiding in the opening and/or closing of the barrier.

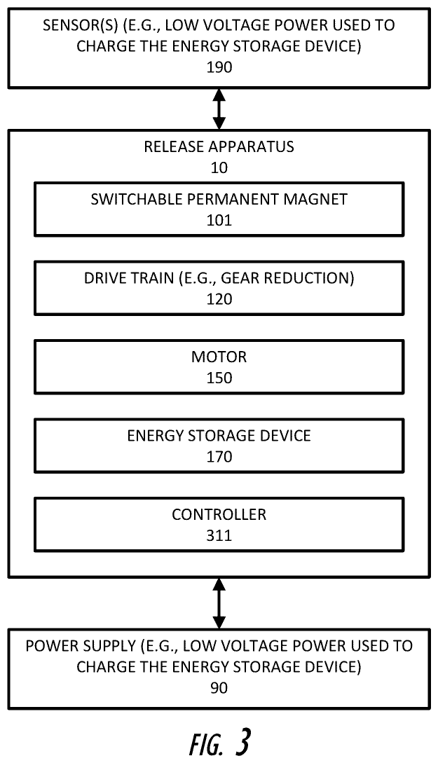

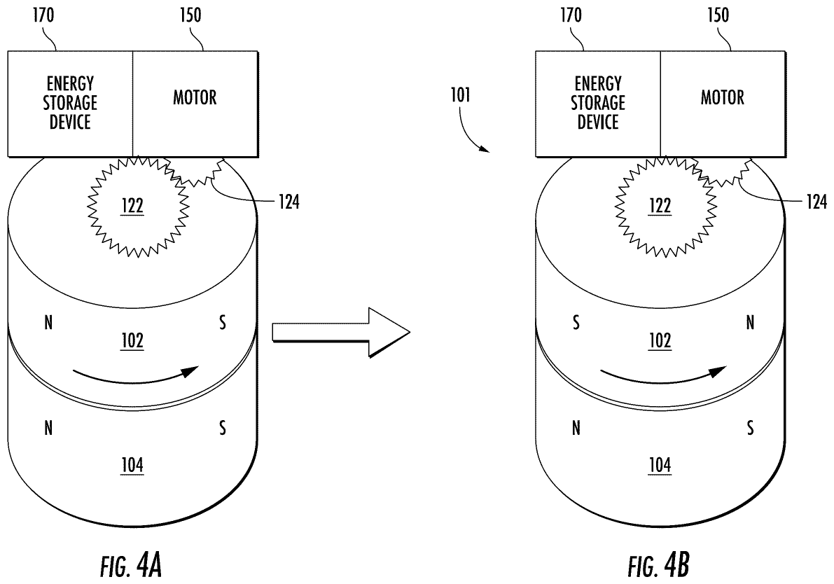

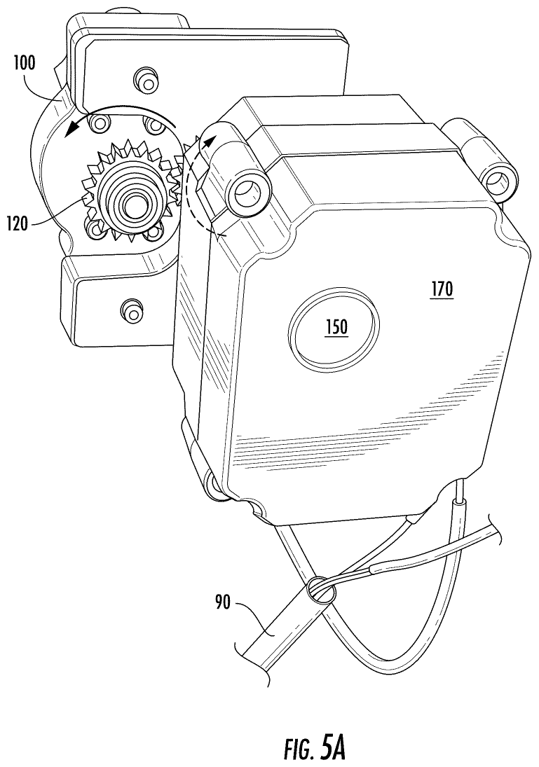

FIGS. 3 through 5B illustrate embodiments of the release apparatus 10 in further detail. As illustrated in the figures, the release apparatus 10 may comprise a switchable magnet 101, a drive train 120, a motor 150, an energy storage device 170, and a controller 311. Moreover, the energy storage device 170 may be operatively coupled to a power supply 90. As illustrated in FIGS. 4A and 4B, the magnet 100 may be a switchable magnet 101 (e.g., switchable permanent magnet, or the like). The switchable magnet 101 allows the magnetic field of the magnet to be activated or deactivated (e.g., turned-on or turned-off, redirected). In some embodiments, as will be described in further detail herein, the magnetic field is adjusted in order to adjust the holding force of the switchable magnet 101. It should be understood that the switchable magnet 101 can be any type of switchable magnet; however, as illustrated in FIGS. 4A and 4B, the switchable magnet 101 may comprise a first permanent magnet 102 (e.g., a cylindrical magnet, or other shaped magnet) stacked on top of a second permanent magnet 104 (e.g., a cylindrical magnet, or other shaped magnet). In some embodiments the first and second magnets 102, 104 may be disc-shaped such that the heights of the magnets 102, 104 may be less than the diameters of the magnets. However, it should be understood that the first and second magnets 102, 104 may be any type of size and shape. Regardless of whether or not the holding force may be adjusted (e.g., based on the relative positions of the magnets), the holding force of the magnet 100 may be 5, 6, 7, 8, 9, 10, 15, 20, 25, 30, 40, 50, 60, 70, 80, 90, 100 or other like lbs., or may range between, overlap, or fall outside of any of these values.

In some embodiments, the first and second magnets 102, 104 may be housed in a housing (e.g., one or more housing portions) that allow at least one of the magnets to rotate with respect to the other within the housing. The housing may be formed of one or more portions that act as passive poles and/or may be formed from a material having a low magnetic reluctance (e.g., iron, or the like). Moreover, the one or more portions of the housing may be shaped in order to reflect the magnetic field strength from the permanent magnets 102, 104 around the perimeter of the permanent magnets 102, 104. It should be understood that the second magnet 104 may be fixed within the housing, while the first magnet 102 rotates, or vice versa. However, in other embodiments, both the first magnet 102 and the second magnet 104 may rotate. The first permanent magnet 102 and the second permanent magnet 104 may be magnetically separated (e.g., with an air gap, using high reluctance materials, or the like). The magnet 102, 104 that is moveable (e.g., illustrated as the first magnet 102) is operatively coupled to the drive (e.g., the motor 150, the actuator, or the like) in order to allow the drive to rotate the first magnet 102, as will be described in further detail herein. In some embodiments, the drive (e.g., motor 150, actuator, or the like) is operatively coupled to the first magnet 102 through one or more magnet members (e.g., bars, axials, shafts, or the like). The housing may at least partially enclose (e.g., close the majority of, or the like) the switchable magnet 101 in order to provide a liquid and/or debris resistant housing such that liquid and/or debris (e.g., dust, dirt, or the like) is restricted from propagating into the housing and interfering with the magnets 102, 104 (e.g., damaging the magnets 102, 104, restricting the movement of the magnets 102, 104 with respect to each other, or the like).

Regardless of the size and shape of the magnets 102, 104, in order for the switchable magnets 101 to operate, the magnetic fields of the first and second magnets 102, 104 may be generally the same such that when the poles of the first and second magnets 102, 104 are at least partially aligned the first and second magnets 102, 104 provide a desired holding force, as illustrated in FIG. 4A. Alternatively, when the magnetic fields of the first and second magnets 102, 104 are misaligned at least the majority of the magnetic fields cancel each other out, as illustrated in FIG. 4B, and the switchable magnet 101 does not have a holding force large enough to engage with the holder 50. That is, as illustrated in FIG. 4A the north poles and south poles of the first magnet 102 and the second magnet 104 align when the switchable magnet 100 is completely aligned. In this engaged position, the magnetic field of the combined magnets 102, 104 are strong and provide the maximum holding force to keep the door 4 open. Alternatively, as illustrated in FIG. 4B the north pole of the first magnet 102 is aligned with the south pole of the second magnet 104, and the south pole of the first magnet 102 is aligned with the north pole of the second magnet 104. In the misaligned position illustrated in FIG. 4B, the first and second magnets 102, 104 are opposed, which results in an external magnetic field that is low (e.g., minimal, negligible, or canceled) such the release apparatus 10 releases the door holder 50.

It should be understood that different magnets 102, 104 may be used to provide different holding forces between the release apparatus 10 and the door holder 50. The holding force is a measurement of the amount of force required to separate the magnet 100 from the object it is holding (e.g., door 4, or the like). For example, different installations may require different holding forces based on the door (e.g., size, weight, or the like), application in which the door holder and release 1 is being used (e.g., fire rated application, or the like), customer preferences, industry regulations, city, county, state or country regulations, or the like. As such, the release apparatus 10 may utilize different magnets to provide different holding forces. Alternatively, the holding force of the magnets 102, 104 may be adjusted by varying the position of the first magnet 102 with respect to the second magnet 104. For example, the switchable magnet 101 may have a maximum holding force when the magnets 102, 104 are fully aligned (e.g., zero degrees of offset between the poles), as illustrated in FIG. 4A. Alternatively, the switchable magnet 101 may have a minimum holding force (e.g., which may be zero, negligible, or small) when the magnets 102, 104 are fully misaligned (e.g., when the poles are rotated one-hundred eighty degrees from each other), as illustrated in FIG. 4B. However, in some embodiments, the rotation of the magnets 102, 104 with respect to each other may be set such that the magnets 102, 104 are only partially aligned (e.g., at an angle between zero and one-hundred eighty degrees). As such, in some embodiment an upper holding force may be set between the range of the maximum and minimum holding force.

As such, a holding force device may be utilized to set the holding force of the magnet 100. The holding force device may be a mechanical, electromechanical, and/or computer implemented system that is able to adjust the holding force. In some embodiments, the holding force device is an adjustable stop (not illustrated) that may be used to set the angle at which the magnets 102, 104 may be able to rotate with respect to each other. In some embodiments, the adjustable stop may prevent the first magnet 102 from being fully aligned with the second magnet 104 through the use of one or more projections and/or one or more grooves in the housing, first magnet 102, and/or the second magnet 104. The projections and/or grooves may be adjustable through an adjustment member (e.g., screw, lever, slide, or the like) that changes location of the projection and/or a stop in a groove to set the holding force. In other embodiments, a controller 311 and/or sensors 190 may be used to control the range of motion of the drive (e.g., motor 150, actuator, or the like) in order to position the first magnet 102 with respect to the second magnet 104, as will be described in further detail below. For example, the controller 311 may be set to only allow the drive (e.g., the motor 150, the actuator, or the like) to rotate the first magnet 102 to an angular position with respect to the second magnet 104 directly, or indirectly (e.g., based on a location of the first magnet 102 with respect to the housing, another member, or the like). In some embodiments one or more sensors 190, such as a position sensor, may be utilized in order to determine the position of the first magnet 102 with respect to the second magnet 104, such that the controller 311 operates the drive (e.g., the motor 150, the actuator, or the like) to move the first magnet 102 with respect to the second magnet 104 to set the holding force of the magnet 100 when the release 10 is engaged. In still other embodiments, a holding force sensor may be utilized to determine the holding force of the magnet 100 (e.g., continuously, intermittently, or upon request).

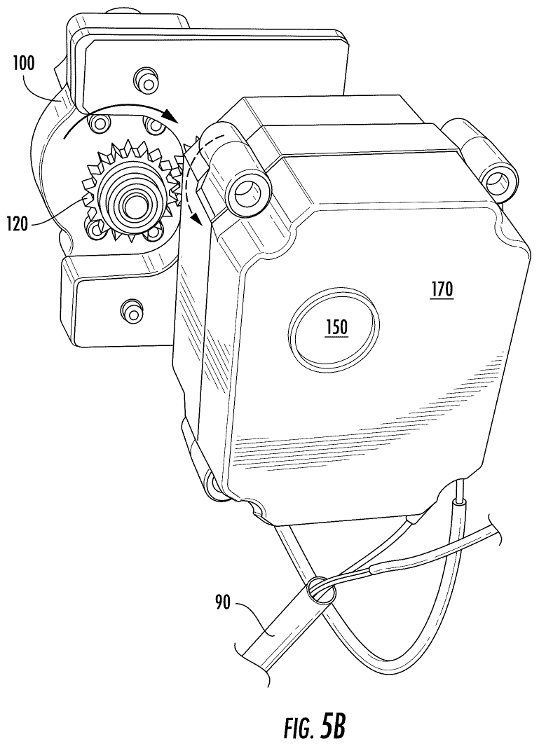

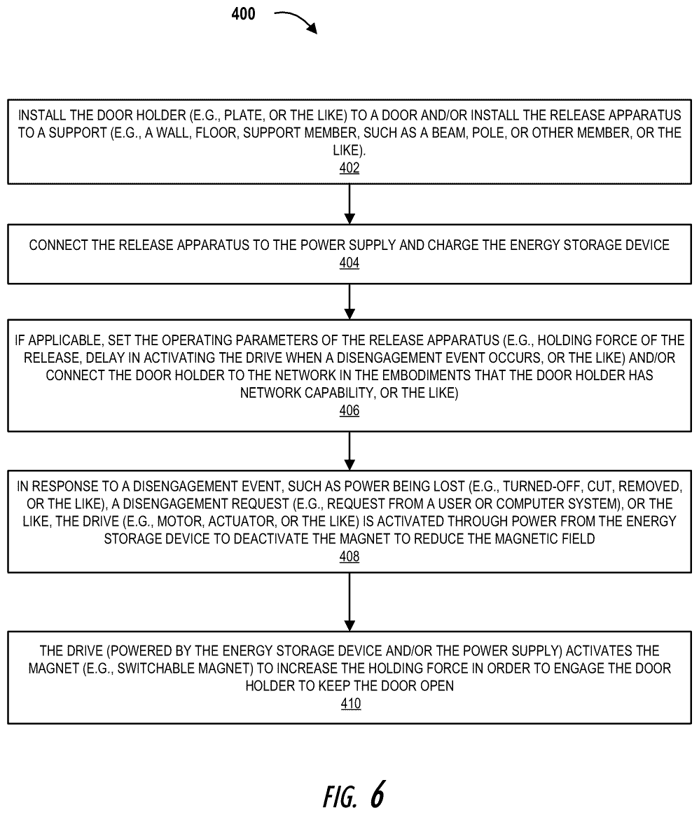

In some embodiments the drive, such as the motor 150, is operatively coupled to the first magnet 102 using a drive train 120. In some embodiments the drive train utilizes gear reduction through the use of one or more gears, such as a first gear 122 and a second gear 124. The gear reduction may be large in order to lower the current utilized, as described below. The gears 122, 124 may provide a reduction ratio of 1:50, 1:75, 1:100, 1:125, 1:150, 1:175, 1:200, 1:225, 1:250, 1:275, 1:300, 1:350, 1:400, or the like. It should be understood that the gear reduction may be any ratio, and thus, range between, overlap, and/or fall outside of any of these values. The gear reduction may be utilized to provide more torque and/or lower the current needed to operate the motor 150. As such, the drive train 120 may be utilized to reduce the size of the motor 150, and thus, the current required to operate the motor 150, while maintaining the torque (e.g., minimum torque, such as with a factor of safety) needed to switch the switchable magnet 101 using the power from the energy storage device 170. As such, the motor 150 may have very low torque with high RPMs and a very large gear reduction. FIGS. 5A and 5B illustrate that the motor 150 may turn in two directions in order to increase and/or decrease the magnetic field; however, in other embodiments the motor 150 may only rotate in a single direction for increasing and/or decreasing the magnetic field of the switchable magnet 101. While the drive is generally discussed herein as a motor 150, it should be understood that the drive may be also be an actuator, such as a rotary, linear, screw, or other like actuator that may utilize electricity, air or other fluid to move one of the magnets, as previously discussed with respect to the motor 150.

The energy storage device 170 may be any type of energy storage device 170, such as, but not limited to a capacitor, a rechargeable battery, or the like, or combinations thereof. When the release 10 is engaged, the switchable permanent magnet 101 has a magnetic field with a holding force that engages with the door holder 50 to keep the door open. In this state, power from the power supply 90 is only being used to charge the energy storage device 170 (e.g., recharge, maintain the charge, or the like). Depending on the voltage of the release apparatus (e.g., 5V, 12V, 18V, 24V, 120V, or the like) only a small amount of milliamps may be needed to charge the energy storage device 170. In some embodiments, a single release apparatus 10 may be able to operate at different voltages (e.g., 5V, 12V, 18V, 24V, 120V, or the like). In some embodiments the release apparatus 10 may be 12V device and may only require a small amount of milliamps (e.g., 0.05, 0.06, 0.07, 0.08, 0.09, 0.1, 0.5, 1.0, 2, 3, 4, 5, or the like) to charge the energy storage device 170. Alternatively, traditional releases that utilize electromagnets to maintain the magnetic field in order to keep the release engaged with the door holder 50 may utilize 50 to 200 milliamps at 12V. In the traditional releases, when disengagement occurs (e.g., experiencing a power loss, disengagement request, or the like) the electromagnet loses its magnetic field, and the release is disengaged from the door holder. Alternatively, in the present invention, when the power is lost the drive (e.g., motor 150, actuator, or the like) is powered by the energy storage device 170 in order to switch the switchable magnet 101 to reduce the magnetic field such that the holding force is reduced so that the release 10 disengages with the door holder 50. However, the energy needed to charge the energy storage device 170 in the present disclosure is much less than the energy required to maintain the magnetic field of the electromagnetic magnet utilized in traditional releases. As such, the present invention provides a door holder and release system 1 that uses much less power, and thus, reduces energy costs, when compared to traditional door holder and release systems.

As noted above, the power consumption of the release apparatus of the present invention is improved over traditional release apparatuses. As an example, actual power consumption is defined by Power (P) in watts, which is equal to the Current (I) in Amps multiplied by Volts (V). Traditional example door releases may have 2.4 W of power (e.g., 120 V at 0.020 amp), 0.48 W of power (e.g., 24V at 0.020 amp), or 0.48 W of power (e.g., 12V at 0.040 amp). As such, the power to hold a door open for these example door holders for 24 hours a day and 7 days a week for a year (52 weeks) would be approximately 21 kWh, 4.2 kWh, and 4.2 kWh, respectively. Alternatively, in the present invention using low voltage power over ethernet (POE), which is a 5V power supply, the present invention may operate in the low milliamp range of approximately 0.1 milliamp. As such, the actual power used (e.g., just maintaining the power in the energy storage device 170) 24 hours a day for 7 days a week for a year would be approximately 0.004 kWh. As such, the present invention could reduce the amount of power used with respect to traditional release apparatus by approximately 1000 to 5000 percent. However, it should be understood that dependent on the voltage and current of various devices the present invention may provide 100, 200, 300, 400, 500, 600, 700, 1000, 1500, 2000, 2500, 3000, 3500, 4000, 4500, 5000, or more in reduction of power usage (or may range between, overlap, or fall outside of these percentages). As illustrated in the above example, the release apparatus 10 of the present invention may provide vast improvements in energy usage with respect to traditional release devices, in particular, for large buildings that may utilize a large number of release apparatuses (e.g., schools, hospitals, office buildings, or the like).

In some embodiments, the release apparatus 10 may be operatively coupled to one or more sensors 190 (e.g., attached directly or indirectly to the release apparatus 10), which may monitor the release apparatus 10, communicate with the release apparatus 10, send signals over the network separate from the release apparatus 10, or the like. In some embodiments, the one or more sensors 190 may comprise a magnetic bond sensor, a door sensor, a position sensor, or other like sensor that may indicate whether or not the release apparatus 10 is activated or deactivated, the position of the door, whether or not the door is opened or closed, the position of the first magnet 102 with respect to the second magnet 104, or the like.

It should be understood that in one embodiment of the invention, the magnet 100 of the release apparatus is a switchable permanent magnet 101. However, it should be understood that in other embodiments different types of magnet apparatuses may be utilized to perform the same or similar function. For example, in some embodiments, an electro-permanent magnet may be stacked on top of a permanent magnet. In the aligned position the electro-permanent magnet may have a magnetic field that aligns with the with the permanent magnet. As such, in this configuration, power from the power supply 90 is not needed to hold the magnetic field of the electro-permanent magnet. Instead, power from the power supply 90 is used to charge the energy storage device 170. When a disengagement event occurs (e.g., power is lost, a disengagement request is made, or the like), instead of using the power in the energy storage device to power a motor 150 to switch the switchable permanent magnet 101, the power from the energy storage device 170 is used to switch the magnetic field of electro-permanent magnet, and thus, cancel the magnetic field of the permanent magnet with which the electro-permanent magnet is stacked. Therefore, the release apparatus 10 will release the door holder 50, and after a period of time (e.g., seconds, when the energy storage device runs out of power, or the like) the power to the electro-permanent magnet is removed and the original magnetic field is returned such that the holding force created by the electro-permanent magnet and the permanent magnet returns to reengage with the door holder 50.

In other alternate embodiments, instead of using an electric energy storage device, the energy storage device may be a mechanical energy storage device, such as a spring (e.g., a coiled spring, or the like). During the disengagement event (e.g., a power loss, disengagement request, or the like), the mechanical energy storage device (e.g., the spring) switches the switchable permanent magnet (e.g., rotates the first magnet 102 with respect to the second magnet 104), such that the holding force is reduced and the release apparatus 10 releases the door holder 50. When a reengagement event occurs (e.g., power is restored, an engagement request is made, or the like) the drive (e.g., the motor 150, the actuator, or the like) may be used to reset the mechanical energy storage device (e.g., rewind the spring, or the like).

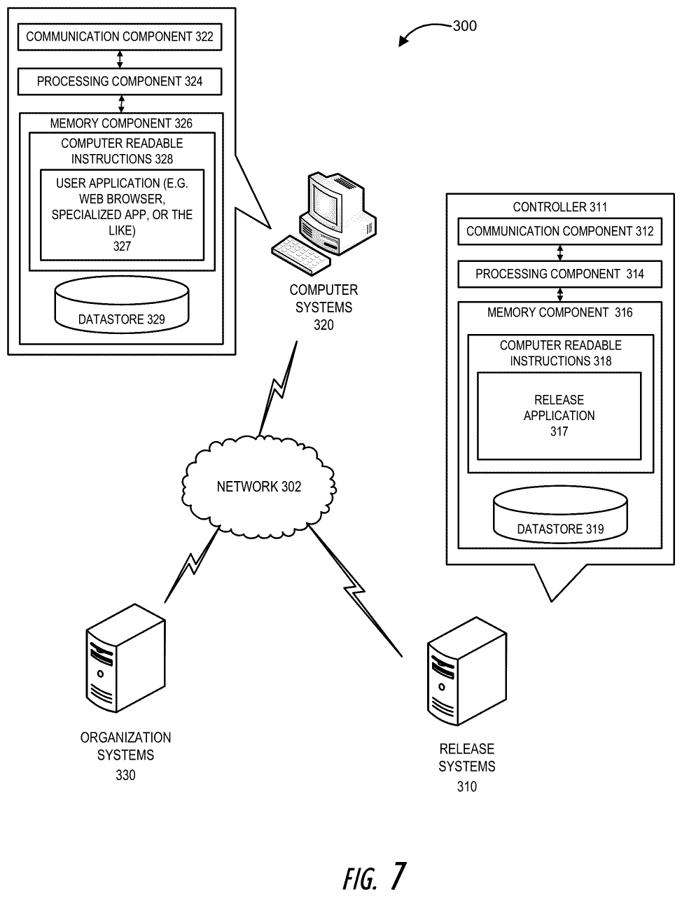

FIG. 6 illustrates a process 400 of installing and operating the door holder and release system 1 described herein. It should be understood that the steps of the process 400 described herein may be performed in any order depending on the installer or the location on which the door holder and release system 1 is installed. As illustrated in block 402, the door holder 50 (e.g., plate or the like) is installed on the door 4. Moreover, the door release apparatus 10 is installed to a support, such as a wall 2, a floor, a support member, or the like. The door holder 50 and/or the release apparatus 10 (e.g., housing thereof) may be installed though connectors (e.g., clips, clamps, welds, adhesives, fasteners, such as screws, or other like connectors).

FIG. 6 further illustrates in block 404 that the release apparatus 10 is connected to the power supply 90, and in particular, to the controller 311 and/or the energy storage device 170. For example, in some embodiments the power supply is a 120V wiring that is connected to the release apparatus 10. In other embodiments, the power supply 90 may be an ethernet connection, network connection, and/or other wired connection that provides power to the energy storage device 170. In other embodiments, the power supply 90 may be a low voltage supply (e.g., 5V, 12V, 18V, 24V, or the like) from a central supply and wired with low voltage wire. In still other embodiments the power supply 90 may be a wireless power supply 90 that provides power with contact and/or contactless connections between the power supply 90 and the release apparatus 10 or the components thereof. The power supply 90 may begin to charge the energy storage device 170 once the release apparatus 10 is connected and/or activated. In some embodiments, the power supply 90 may supply power to the controller 311 or other components of the release apparatus 10, or sensors 190 to which the release apparatus 10 may be operatively coupled.

Block 406 further illustrates that in the embodiments in which the release apparatus 10 has programmable operating parameters, the installer may locally set the operating parameters. Alternatively, the programmable operating parameters may be set automatically or by a remote user through a networked connection during or after installation of the door holder and release system 1. The operating parameters may include the door holding force (e.g., by setting an upper limit on the rotation between the first magnet 102 and the second magnet 104). In other embodiments, the operating parameters may include a delay in activating the drive (e.g., motor 150, actuator, or the like) during the disengagement event. For example, in some embodiments the power loss may only be out for fractions of a second, a second, a few seconds (e.g., 2, 5, 10, 15, 20, 30, or the like). As such, in some embodiments, an operating parameter may include a delay in activating the motor 150 (or other drive) such that the door 4 is not closed due to a short interruption in the supply of power. In other embodiments, when the release assembly 10 has network capabilities, the controller 311 may be automatically connected to the network 302 and/or the installer may activate the release apparatus 10 for connection to the network 302.

FIG. 6 further illustrates in blocks 408 and 410 the operation of the door holder and release system 1 after installation. As illustrated in block 408 of FIG. 6, in response to a disengagement event, such as power loss (e.g., power is turned off, cut, removed, or the like), in particular embodiments due to a fire in a building, or in response to a disengagement request (e.g., a user or computer requests the door to be closed) a signal is sent to operate the motor 170. Even though the power supply 90 is lost or a disengagement request has been made, the energy storage device 170 maintains enough power to allow the motor 150 to operate. As such, the drive (e.g., motor 150, actuator, or the like) directly, or through the drive train 120 (e.g., the gears 122, 124), moves (e.g., rotates, or the like) the first magnet 102 with respect to the second magnet 104 in order to reduce (e.g., decrease, minimize, or eliminate) the magnetic field of the magnet 100 such that the magnet 100 disengages from the door holder 50 and allows the door 4 to close (e.g., through a door closer, door operator, biased springs, biased hinges, or the like).

Block 410 of FIG. 6 illustrates that the drive (e.g., motor 150, actuator, or the like) directly, or through the drive train 120 (e.g., the gears 122, 124), moves (e.g., rotates, or the like) the first magnet 102 with respect to the second magnet 104 in order to raise (e.g., increase or activate) the magnetic field of the magnet 100 such that the magnet 100 would have a holding force that engages with the door holder 50 in order to hold the door 4 open. In some embodiments, the drive (e.g., motor 150, actuator, or the like) is reactivated by the energy storage device 170 after a period of time (e.g., 5, 10, 30, 60 seconds, or the like) in order to raise the magnetic field such that the magnet 100 has the holding force to engage with the door holder 50. In other embodiments, the drive (e.g., motor 150, actuator, or the like) is only reactivated by the power supply 90 once the power is restored. In this way, the door 4 could not be inadvertently opened and held open by the release apparatus 10 while the power remains lost.

As previously described herein, the release apparatus 10 of the present disclosure provides improvements over traditional releases at least because it utilizes much less power than traditional releases that rely on electro-magnets that must draw much higher amps (e.g., 50-200 milliamps, or the like) in order to maintain the holding force while the door 4 is being held open. As such, the present invention uses much less energy than traditional release apparatuses, and in particular, when an entire building utilizes the door holder and release 1 system of the present invention a significant cost savings can be achieved.

As previously discussed herein, the door holder and release system 1 may accessed through a networked connection and/or controlled through the use of a programmable controller 311. As such, the operation of the release apparatus 10 of the door holder and release system 1, may be controlled by a programmable controller 311 of a release system 310, which may communicate with other systems. FIG. 7 illustrates a release network environment system 300, in accordance with embodiments of the present disclosure. As illustrated in FIG. 7, one or more release systems 310 are operatively coupled, via a network 302, to one or more user computer systems 320, one or more organization systems 330, and/or one or more other systems (not illustrated). In this way, the release system(s) 310 operating the release apparatus 10 may communicate with one or more user computer system 320, one or more organization systems 330, and/or one or more other systems (not illustrated) for sending and receiving signals regarding the operation of the release apparatus 10, such as changing the holding force of the release apparatus 10, sending and receiving alerts related to the release apparatus 10, or the like. Moreover, in some embodiments, a remote user may be able to disengage (and thereafter may engage) one or more release apparatuses 10 within a building through the use of a disengagement request (e.g., should the user and/or a computer system manually and/or automatically wish to close one or more doors of a building). As such, the release systems 310 may communicate with user computer systems 320 to allow the user computer systems 320 to monitor and/or operate the release apparatus 10. Moreover, the release systems 310 may communicate with each other and/or other systems, such as the organization systems 330 and/or other systems (not illustrated) for monitoring and/or controlling of networked devices (e.g., door operators, door closers, access control devices, cameras, sensors, or the like) within a building management system. The communications may occur over a network 302, as will be described in further detail herein.

The network 302 may be a global area network (GAN), such as the Internet, a wide area network (WAN), a local area network (LAN), or any other type of network or combination of networks. The network 302 may provide for wireline, wireless, or a combination of wireline and wireless communication between systems, services, components, and/or devices on the network 2.

As illustrated in FIG. 7, the one or more release systems 310 may comprise a controller 311 that may generally comprise one or more communication components 312, one or more processing components 314, and one or more memory components 316. The one or more processing components 314 are operatively coupled to the one or more communication components 312, and the one or more memory components 316. As used herein, the term “processing component” generally includes circuitry used for implementing the communication and/or logic functions of a particular system. For example, a processing component may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components may include functionality to operate one or more software programs based on computer-readable instructions thereof, which may be stored in the one or more memory components.

The controller 311 components, such as the one or more communication components 312, may be operatively coupled to one or more sensors 190 (e.g., magnetic bond sensor, position sensor, lock engagement sensor, or the like as previously discussed herein) located within the door holder and release system 1 and/or located within a door system in which the door holder and release system 1 operates.

The one or more processing components 314 use the one or more communication components 312 to communicate with the network 302 and other components on the network 302, such as, but not limited to, the components of the one or more user computer systems 320, the one or more organization systems 330, and/or the one or more other systems (not illustrated). As such, the one or more communication components 312 generally comprise a wireless transceiver, modem, server, electrical connection, electrical circuit, or other component for communicating with other components on the network 302. The one or more communication components 312 may further include an interface that accepts one or more network interface cards, ports for connection of network components, Universal Serial Bus (USB) connectors, or the like. Moreover, the one or more communication components 312 may include a keypad, keyboard, touchscreen, touchpad, microphone, mouse, joystick, other pointer component, button, soft key, and/or other input/output component(s) for communicating with the users. In some embodiments, the one or more communication components 312 may comprise a user interface, such as a graphical user interface that allows a user to communicate with, control, and/or monitor the release apparatus 10.

As further illustrated in FIG. 7, the one or more release systems 310 comprise computer-readable instructions 318 stored in the one or more memory components 316, which in some embodiments includes the computer-readable instructions 318 of the one or more release applications 317 (e.g., used to operate the release apparatus 10 and/or the components thereof, or the like). In some embodiments, the one or more memory components 316 include one or more data stores 319 for storing data related to the release 10, including, but not limited to, data created, accessed, and/or used by the release systems 310 to operate the release apparatus 10.

As illustrated in FIG. 7, users may communicate with each other, the release systems 310, the organization systems 330, and/or other systems over the network 302 in order to control and/or monitor the various systems remotely. Consequently, the one or more users 4 may be employees, agents, representatives, officers, or the like of an organization operating, monitoring, or controlling the facility and/or the devices therein. The one or more user computer systems 320 may be a desktop, laptop, tablet, mobile device (e.g., smartphone device, or other mobile device), or any other type of computer that generally comprises one or more communication components 322, one or more processing components 324, and one or more memory components 326.

The one or more processing components 324 are operatively coupled to the one or more communication components 322, and the one or more memory components 326. The one or more processing components 324 use the one or more communication components 322 to communicate with the network 302 and other components on the network 302, such as, but not limited to, the one or more release systems 310, the one or more organization systems 330, and/or the other systems (not illustrated). As such, the one or more communication components 322 generally comprise a wireless transceiver, modem, server, electrical connection, or other component for communicating with other components on the network 302. The one or more communication components 322 may further include an interface that accepts one or more network interface cards, ports for connection of network components, Universal Serial Bus (USB) connectors and the like. Moreover, the one or more communication components 322 may include a keypad, keyboard, touchscreen, touchpad, microphone, mouse, joystick, other pointer component, button, soft key, and/or other input/output component(s) for communicating with the users. In some embodiments, the one or more communication components 322 may comprise a user interface, such as a graphical user interface that allows a user to remotely communicate with, control, and/or monitor the operation of the release apparatus 10.

As illustrated in FIG. 7, the one or more user computer systems 320 may have computer-readable instructions 328 stored in the one or more memory components 326, which in some embodiments includes the computer-readable instructions 328 for user applications 327, such as dedicated applications (e.g., apps, applet, or the like), portions of dedicated applications, a web browser or other apps that allow access to applications located on other systems, or the like. In some embodiments, the one or more memory components 326 include one or more data stores 329 for storing data related to the one or more user computer systems 320, including, but not limited to, data created, accessed, and/or used by the one or more user computer systems 320. The user application 327 communicates with the applications of the one or more release systems 310, the one or more organization systems 330, and/or one or more other systems (not illustrated) over the network 302 to take the various actions described herein (e.g., operation, use, monitoring, or the like of the release apparatus 10 and/or other devices within one or more buildings).

Moreover, as illustrated in FIG. 7, the one or more organization systems and/or other systems (not illustrated) have components the same as or similar to the components described with respect to the one or more release systems 310 and the one or more user computer systems 320 (e.g., one or more communication components, one or more processing components, one or more sensors, one or more memory devices with computer-readable instructions of one or more product applications, one or more datastores, or the like). Thus, the one or more organization systems 330 communicate with the one or more release systems 310, the one or more user computer systems 320, and/or one or more other systems in the same or similar way as previously described with respect to the one or more release systems 310, the one or more user computer systems 320, and/or the one or more other systems. The one or more organization systems 330 may comprise the systems that operate and/or monitor the door holder and release apparatus 1 and/or other systems within a structure (e.g., building, or the like), while the one or more other systems (not illustrated) may be the systems for the other devices (e.g., door operators, door closers, access entry system, fire/smoke detectors, sprinkler systems, sensors, or the like) within the building that may be controlled and/or monitored by a building management application.

As will be appreciated by one of skill in the art in view of this disclosure, embodiments of the invention may be embodied as an apparatus, a system, computer program product, and/or other device, a method, or a combination of the foregoing. Accordingly, embodiments of the invention may take the form of an entirely hardware embodiment, an entirely software embodiment (including firmware, resident software, micro-code, or the like), or an embodiment combining software and hardware aspects that may generally be referred to herein as a “system.” Furthermore, embodiments of the invention may take the form of a computer program product comprising a computer-usable storage medium having computer-usable program code/computer-readable instructions embodied in the medium (e.g., a non-transitory medium, or the like).

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Python, Smalltalk, C++ or the like. However, the computer program code/computer-readable instructions for carrying out operations of the invention may also be written in conventional procedural programming languages, such as the “C” programing language or similar programming languages.

It should be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa.

In addition, where possible, any terms expressed in the singular form herein are meant to also include the plural form and/or vice versa, unless explicitly stated otherwise. Accordingly, the terms “a” and/or “an” shall mean “one or more.” It will be further understood that the terms “includes” and/or “including” when used herein, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and should not be interpreted in an idealized or overly formal sense unless expressly so defined herein. Certain terminology is used herein for convenience only and is not to be taken as a limitation on the invention. For example, words such as top, bottom, front, rear, side, upper, lower, left, right, horizontal, vertical, upward, downward, first, second, third, inside, outside, or other similar terms used herein are intended for illustrative purposes only and do not limit the embodiments in any way. The referenced components may be oriented in any orientation other than that shown in the drawings and the terminology, therefore, should be understood as encompassing such variations unless specified otherwise. All structural and functional equivalents to the elements of the various aspects described throughout the disclosure that are known or later come to be known to those of ordinary skill in the art are expressly incorporated herein by reference and are intended to be encompassed by the claims.

It should be understood that “operatively coupled,” when used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A release apparatus for a door holder and release system, the release apparatus comprising:
a magnet;
a drive operatively coupled to the magnet; and
an energy storage device operatively coupled to the drive;
wherein the energy storage device is configured to be operatively coupled to a power supply for storing energy in the energy storage device; and
wherein during a disengagement event when the power supply is reduced, the energy storage device powers the drive to switch the magnet to reduce a magnetic field of the magnet.

2. The release apparatus of claim 1, wherein the magnet is a switchable permanent magnet.

3. The release apparatus claim 1, wherein the energy storage device comprises a capacitor.

4. The release apparatus of claim 1, wherein the energy storage device comprises a battery.

5. The release apparatus of claim 1, further comprising:
a drive train operatively coupled to the magnet and the drive;
wherein the drive is a motor or an actuator; and
wherein the drive train increases torque or reduces current of the motor or the actuator.

6. The release apparatus of claim 1, wherein the energy storage device utilizes 10 milliamps or less to charge the energy storage device.

7. The release apparatus of claim 1, wherein the power supply operatively coupled to the energy storage device comprises a 12V, 18V, 24V, or 120V power supply.

8. The release apparatus of claim 1, wherein the power supply operatively coupled to the energy storage device comprises power over ethernet.

9. The release apparatus of claim 1, further comprising:
a sensor for sending a signal to indicate a status of the magnet.

10. The release apparatus of claim 9, wherein the sensor is a magnetic bond sensor, and the signal indicates when the magnet is engaged or disengaged or a magnet holding force.

11. The release apparatus of claim 1, further comprising a controller comprising:
one or more memories having computer readable code stored thereon; and
one or more processing devices operatively coupled to the one or more memories, wherein when executed the computer readable code is configured to cause the one or more processing devices to:
receive a selection of a holding force for the magnet; and
activate the drive to adjust the magnet to set the holding force.

12. The release apparatus of claim 1, further comprising a controller comprising:
one or more memories having computer readable code stored thereon; and
one or more processing devices operatively coupled to the one or more memories, wherein when executed the computer readable code is configured to cause the one or more processing devices to:
receive a signal to activate the drive; and
engage the drive to reduce the magnetic field from the magnet.

13. The release apparatus of claim 12, wherein the signal is a loss of power from the power supply, and wherein engaging the motor to reduce the magnetic field comprises using the energy storage device to provide the power the motor.

14. A door holder and release system, the system comprising:
a door holder configured to be operatively coupled with a door;
a release apparatus configured for operative coupling with a support, the release apparatus comprising:
a magnet;
a drive operatively coupled to the magnet; and
an energy storage device operatively coupled to the drive;
wherein the energy storage device is configured to be operatively coupled to a power supply for storing energy in the energy storage device; and
wherein during a disengagement event when the power supply is interrupted, the energy storage device powers the drive to switch the magnet to reduce a magnetic field of the magnet.

15. The door holder and release system of claim 14, wherein the magnet is a switchable permanent magnet, and wherein the energy storage device comprises a capacitor.

16. The door holder and release system of claim 14, wherein the release apparatus further comprises:
a drive train operatively coupled to the magnet and the drive;
wherein the drive is a motor or an actuator; and
wherein the drive train increases torque or reduces current of the motor or the actuator.

17. The door holder and release system of claim 14, wherein the energy storage device utilizes 10 milliamps or less to charge the energy storage device.

18. The door holder and release system of claim 14, wherein the power supply operatively coupled to the energy storage device comprises a 12V, 18V, 24V, or 120V power supply or power over ethernet.

19. The door holder and release system of claim 14, wherein the release apparatus further comprises a controller comprising:
one or more memories having computer readable code stored thereon; and
one or more processing devices operatively coupled to the one or more memories, wherein when executed the computer readable code is configured to cause the one or more processing devices to:
receive a signal to activate the drive; and
engage the drive to reduce the magnetic field from the magnet.

20. A method of controlling a release apparatus of a door holder and release system, the release apparatus comprising a magnet, a drive operatively coupled to the magnet, and an energy storage device operatively coupled to the drive, the method comprising:
identifying a disengagement event; and
activating the drive using the energy storage device to power the drive to reduce a magnetic field of the magnet.
